(19) United States
(12) Patent Application Publication
(10) Pub. No.: US 2004/0032493 A1
(43) Pub. Date: Feb. 19, 2004

(54) Method for monitoring the interior and/or exterior of a vehicle, and a vehicle having at least one survaillance camera

(75) Inventors: Uwe Franke, Uhingen (DE); Stefan Gehrig, Boeblingen (DE); Valery Menjon, Ulm (DE); Fridtjof Stein, Ostfildern (DE); Alexander Wuerz-Wessel, Salach (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/462,530

(22) Filed: Jun. 16, 2003

(30) Foreign Application Priority Data
Jun. 18, 2002 (DE) 102 27 221.2

(51) Int. Cl. H04N 7/18

(52) U.S. Cl. 348/148; 348/143; 340/425.5

(57) ABSTRACT

A method for monitoring a space of a vehicle. The method includes sensing the space using a first sensor including at least one surveillance camera so as to produce an image data, performing an evaluation of the image data, selecting at least one area of the space using the evaluation of the image data, sensing the at least one area using a second alignable sensor having a restricted spatial sensing range so as to produce a second data, and evaluating the second data. In addition, a vehicle that includes a first sensor having at least one surveillance camera disposed in an interior of the vehicle, the first sensor having a field of view at least partially covering at least one of the interior and an exterior of the vehicle, and a second alignable sensor having a restricted spatial sensing range, an alignment of the second sensor being controllable using the first sensor.

Priority is claimed to German Patent Application No. DE 102 27 221.2-51, filed on Jun. 18, 2002, which is incorporated by reference herein.

### BACKGROUND

The invention relates to a method for monitoring the interior and/or exterior of a vehicle, and to a vehicle having at least one surveillance camera in the vehicle interior.

Motor vehicles having a camera in the vehicle interior are known, for example, individual cameras with a field of view to the outside can be used to monitor the front, side and/or rear spaces through the window panes of the vehicle. Again, cameras have already been proposed for observing parts of the vehicle interior, for example in German Patent Application No. DE-A-198 03 158, which exhibits a device for optically determining the state of vigilance of the operator of a vehicle.

The unpublished German patent application previously applied for by the applicant and having the official file reference DE 101 58 415.6 discloses a method for optically monitoring the interior of a vehicle with at least one surveillance camera. In this case, the sensing of the exterior is also represented by at least one surveillance camera. This described mode of procedure requires complicated evaluation of the image data, the informativeness of the evaluated data not always being sufficient.

### SUMMARY OF THE INVENTION

It is an object of the present invention to create a method for monitoring the interior and/or exterior of a vehicle as well as a vehicle having a sensor system for carrying out a method which can make available detailed information with appropriate reliability.

The present invention provides a method for monitoring the interior and/or exterior of a vehicle having a sensor that is formed by at least one surveillance camera, in the case of which the interior and/or exterior is sensed by the surveillance camera and the image data are evaluated, wherein the evaluation is used to select at least one area, and wherein this area is sensed by means of a second alignable sensor with a restricted spatial sensing range and the data recorded by the second sensor are subjected to an evaluation. The present invention also provides a vehicle having a first sensor which is formed by at least one surveillance camera in the interior of the vehicle and whose field of view at least partially covers the interior and/or exterior of the vehicle, wherein a second sensor is provided which has a restricted spatial sensing range and whose alignment can be controlled as a function of the first sensor.

Advantageous developments of the present invention are described in the specification and claims.

In accordance with the present invention, the vehicle interior and the vehicle exterior, as well, are observed by means of at least one surveillance camera that comprises, in a preferred embodiment, a conventional digital, particular CCD, camera and a, for example, spherically or parabolically convex mirror that is set apart from the camera and is observed, in turn, by the camera. Surveillance cameras in an integrated housing have also proved themselves, in addition. Surveillance cameras are described, for example, in PCT international patent publications WO 99/30197, WO 99/45422 and WO 97/43854, and are used, for example, for monitoring purposes and in the case of robot navigation. They typically produce a 360° panoramic image in a way similar to a fish eye camera. Unlike fish eye cameras, which virtually no longer permit details to be recognized on the taking horizon, that is to say at the edge of its azimuthal taking range of max. 180°, surveillance cameras also reproduce details in the edge region of an image and thereby even permit, if appropriate, azimuthal taking ranges of more than 180°.

Given a suitable arrangement of the surveillance camera, in particular in the region of the inside mirror, a very large part of the vehicle interior, and also of the vehicle exterior, can be sensed at once. It has also proved effective to arrange a convex mirror in the vehicle interior on the vehicle roof, as a result of which the entire hemisphere situated therebelow, that is to say virtually the entire vehicle interior, and also the exterior that can be sensed through the side window panes, can be taken.

It has proved effective, furthermore, to integrate the convex mirror or the camera itself in the dashboard, in particular when it is principally the front area of the vehicle interior and the area in front of the vehicle that are to be monitored. Image data recorded by the surveillance camera can be used to select an interesting area for a more detailed evaluation, and to make use, for a more detailed evaluation, of a second sensor, which is distinguished by a spatially restricted sensing range and is designed to be capable of alignment such that it can be aligned with an area classified as interesting. The data recorded by the second sensor are subjected to an evaluation that gives more detailed information relating to the selected area than is generally permitted by the surveillance camera alone.

The present invention creates a method that can make available reliable information in relevant, selected areas of the exterior or else the interior of the vehicle. The comprehensive recording of the image data of the surveillance camera renders possible a very reliable sensing and selecting of the relevant area or areas of particular interest, without it being possible to overlook or not consider individual areas that can be important for a driving decision. In order to permit a reliable driving decision, the method according to the present invention or the vehicle according to the present invention is used by selecting particularly relevant areas and feeding them to more detailed sensing by a second sensor, in particular one with special properties. The reliability of evaluation, and thus also the driving safety, are substantially increased thereby.

On the basis of the recorded and evaluated image data, the driver can be warned at an early stage, on the one hand, and on the other hand it is possible to effect measures to prevent accidents by means of active intervention in the vehicle, or else to effect measures to limit the severity of consequences of accidents, for example by early triggering of airbags or the like.

According to a particularly preferred embodiment of the present invention, the second sensor is formed from at least a digital camera, an infrared camera, a laser point sensor, a radar sensor or a combination thereof. As a result, the laser point sensor or the radar sensor, in particular, create a very reliable evaluation of the relative behavior of the sensed, selected area of the second sensor in relation to the vehicle. In particular, the relative speed or else the distance from the vehicle is sensed, evaluated and made available for further processing in the vehicle. Precisely through use as second sensors of sensor types that reliably permit sensing of the relative speed of objects in the sensed area, very important information is obtained for preventing, or limiting the consequences of, accidents, and this benefits the driving safety of the vehicle itself, but also of the traffic as a whole, in particular the safety of pedestrians. However, infrared cameras or digital cameras with a relatively large magnification factor, in particular with a zoom function, also prove to be very useful, since they additionally permit substantially more detailed information to be obtained, in particular under unfavorable situations such as fog or dusk or night, in relation to the information obtained by the surveillance camera. This additional information is made available to the vehicle per se or in combination with the data from the first sensor, and the vehicle is correspondingly controlled to enhance traffic safety.

The alignment of the second sensor is preferably performed on the basis of an automated evaluation of the image data of the first sensor, by virtue of the fact that the second sensor is swiveled either by motor, and thereby swivels the restricted sensing range onto another area of the sensing range of the surveillance camera, or electronically, as performed, for example, in the case of a changed drive or phased array radar antenna. In the case of the latter, one and the same radar antenna achieves a different directional characteristic by differentiated driving, without the need for the antenna to be swiveled mechanically or by motor relative to the sensor. Such an electronic alignment of the second sensor proves to be very advantageous, since mechanically swivelable sensors have proved to be very susceptible owing to the continuous shaking and vibration in vehicles.

The alignment of the second sensor is preferably carried out on the basis of automated evaluation of the image data, methods for the analysis of movement, contour and/or color having proved themselves, in particular, for evaluating image data. This evaluation of the image data of the first sensor results in automated selection of an area of particular interest which is subsequently subjected to a thorough more detailed observation by the second sensor. In this case, it has proved to be particularly effective to carry out the selection of the area of interest with the aid of an evaluation of movements in the image of the first sensor, for example by using the optical flux, and this has proved to be particularly effective in the case of using the present invention in conjunction with a device for restricting or preventing collisions with pedestrians or cyclists.

Since the images obtained by the at least one surveillance camera are greatly distorted, that is to say are present in some form of curvilinear “world coordinates”, one or more undistorted partial images are generated therefrom by transforming the images of the camera into cylindrical or plane coordinates. The relationship between the curvilinear coordinate system of the camera images and the cylindrical or plane target coordinate systems is fixed by the mirror geometry and camera and/or by the structure of the surveillance camera. In the transformation, the values of brightness and, if appropriate, color of each image point of a camera image are assigned to a point in the cylindrical or plane coordinate system, whose coordinates result from trigonometric relationships, for example in the case of a spherical mirror.

The corresponding calculations can be carried out substantially in real time in a computer in the vehicle; in order to save computing power, the described assignment is carried out in practice, however, preferably with the aid of one or more transformation tables that are drawn up during a camera calibration and stored for the purpose of use during the camera operation in an onboard computer or a hard-wired electronic image rectification system.

This leads to one or more partial images of the vehicle interior in the case of which substantially only a one-dimensional distortion is present (in the case of a transformation to cylindrical coordinates) or (in the case of a transformation to plane coordinates) no distortion at all is present any more, and so straight lines are essentially reproduced as straight lines. Such images in cylindrical or plane coordinates can then be further processed electronically in a very simple way, in particular they can be evaluated very simply. This permits simple further processing, and thus cost-effective implementation of the present invention in a vehicle. In particular, the evaluation, the selection of a particularly interesting area for closer evaluation by the second sensor with the aid of a selection stage, is made substantially easier. Moreover, it is possible by this transformation to achieve a modularization of the monitoring system for a vehicle, and this permits a simple replacement of the at least one surveillance camera with subsequent transformation to the respective circumstances of a vehicle in conjunction with largely identical subsequent image processing and evaluation with selection of the areas of interest. It is thereby possible to lower substantially the costs for such systems for monitoring the interior and exterior of a vehicle, and thereby to raise the acceptance to the user without appreciable loss in the reliability of evaluation.

The present invention also relates to a vehicle having a first sensor that is formed by at least one surveillance camera in the interior of the vehicle, whose field of view at least partially covers the interior and/or exterior of the vehicle. The first sensor is assigned a second sensor that has a restricted spatial sensing range of which the alignment can be controlled as a function of the first sensor. In this case, the alignment is preferably performed via a control unit that can be controlled on the basis of automated evaluation of the image data of the first sensor, which is preferably carried out by an image evaluation unit, such that a selected region, classified as particularly interesting or relevant, of the visual range of the first sensor is specifically sensed by the second sensor and thoroughly evaluated. In this case, the alignment of the second sensor is performed by means of a control unit that swivels the second sensor preferably by motor, or adapts its alignment correspondingly in an electronic way. The result of this is a preferably automated recording of the relevant information from the exterior or interior of the vehicle with the aid of the selection by a selection stage in conjunction with a corresponding control unit, which is assigned to the first sensor, and a very reliable mode of operation is thereby provided for the method for monitoring the interior and exterior of a vehicle.

It has proved to be especially advantageous either to use the first and/or the second sensor per se in each case, or to use them in common as a stereoscopic sensing system for the interior and/or exterior of the vehicle. Consequently, the recorded information of each sensor which is formed at least by two individual sensors is, for example, formed by two surveillance cameras or from two digital cameras, two infrared cameras, two laser point sensors or two radar sensors or a combination of two such individual sensors in such a way that a stereoscopic evaluation of the sensing range is possible with two individual sensors. In the course of this stereoscopic evaluation, it is possible, in particular, to record and evaluate information relating to the depth graduation of the objects in the sensing range and, in particular, information relating to the distance or else to the change in distance, that is to say the relative speed. This stereoscopic information permits warning functions to be activated very specifically, or activation of defensive strategies for preventing or limiting the effects of accidents by early activation of defensive measures, so-called precrash measures, or else with regard to intervention in the driving behavior of the vehicle, for example by means of independent, autonomous braking or evasion of the vehicle. It is thereby particularly the information relating to the spatial breakdown of the exterior of a vehicle, particularly in the front region, that forms the basis of the control.

The use of infrared cameras, laser point sensors and/or radar sensors results in a very reliable way in expansion of the information content of the sensible surroundings in the interior and/or exterior of the vehicle via the information content of a camera that substantially operates exclusively in the visible frequency range. A substantially differentiated representation of the information relating to the surrounding area is thereby rendered possible and made available for later evaluation of the vehicle.

It has proved effective, in particular, to provide the second sensor with a zoom function. In this case, the zoom function is controlled, in particular, as a function of the distance of the objects in the selected area to the effect that the zoom factor is selected to be large in the case of objects particularly far removed, and the zoom factor is selected to be small in the case of objects in the near zone. It is thereby always possible for information relating to the objects in the selected area to be obtained very reliably and in a detailed fashion substantially covering the entire surface. As a result of this design, unnecessary information owing to unsuitable selection of the section is largely excluded from the recording and evaluation, and this simplifies and normally also accelerates the evaluation.

It has proved to be particularly effective to arrange the first sensor, which includes one or two or also more surveillance cameras, in the roof area, particularly in the region of the inside mirror, and this results in a very advantageously structured sensing range of the first sensor. In particular, the lateral area and the front area of the vehicle can be very effectively sensed through the window panes of a vehicle here, but also so can the interior, in particular the area of the front seats, and can therefore be evaluated very easily with regard to the selected areas.

In addition, it has proved particularly effective to arrange the second sensor in the region of the dashboard, and this supports or else permits to a particular extent observation of the area ahead of the vehicle, the space in front or the space to the side of the vehicle, in particular with regard to application as an intersection assistant, detection of traffic lights or vehicle detection or lane detection. It is possible to a particular extent with this arrangement to make a joint evaluation of the information recorded by the first sensor and the second sensor. In particular, this renders possible a stereoscopic evaluation of the sensed areas, as a result of which, in particular, a spatial subdivision of the jointly sensed area can be recorded, or else the occurrence of instances of ambiguity (multiple hypotheses) can be prevented or limited. The prevention or limitation of instances of ambiguity can be achieved to a particular extent by the use of a plurality of, in particular by three or more, individual sensors whose recorded information is evaluated jointly, for example for the purpose of a trinocular stereo evaluation method. A particular protection against damage or soiling results from an arrangement of the sensors in the interior of the vehicle, and this also affects the quality of the sensor data positively.

In addition, it has proved particularly effective to arrange the second sensor at least partially in the region of the bumpers, the headlamps or the edge region of the vehicle roof, since these are capable, without the hindrance of the side window panes, of directly sensing the area outside and thus of directly sensing the selected area outside. This leads to information relating to the selected areas outside that is more detailed and less falsified. This arrangement of the radar sensor has proved effective to a particular extent where use is made of radar sensors.

By contrast with the case of other conventional optical sensor systems for vehicles, the combination of the at least one surveillance camera in conjunction with the second alignable sensor with a restricted field of view permits a reduction in the number of the cameras required for carrying out the multiplicity of possible tasks in recording information from the interior and/or from the exterior.

In addition to said possible application of the present invention in conjunction with assistant systems for the detection of traffic lights, detection of traffic signs, methods for tracking traffic jams, lane detection, detection of the right/left situations, object detection in the near field, such as cyclists, for example, or sensing and evaluating the situation at an intersection, it is also possible to implement other applications such as an interior monitoring for antitheft security or for documenting traffic situations, particularly in connection with accidents. The applications and image evaluation systems that come to be applied in connection with the present invention do not require calibrated systems; it is also possible to use uncalibrated systems. Again, it is possible to apply the present invention in other vehicles, which are not automobiles, particularly in aircraft or ships, for example for monitoring tasks.

### BRIEF DESCRIPTION OF THE DRAWINGS

Further features and advantages of the present invention emerge from the following description of exemplary embodiments with the aid of the drawing, in which, by way of example:

FIG. 1 shows a sketch of the principle of a device for monitoring the interior and/or exterior of a vehicle in accordance with the present invention;

FIG. 2 shows a sketch of an image of a surveillance camera; and

FIG. 3 shows a rectified partial image in accordance with FIG. 2.

### DETAILED DESCRIPTION

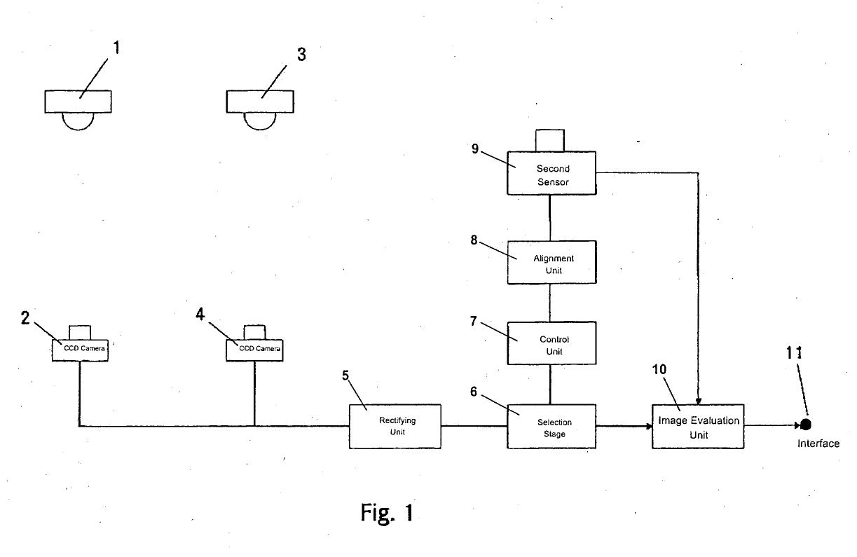

An exemplary design of an arrangement according to the present invention for monitoring the interior and/or exterior of a vehicle having two surveillance cameras is illustrated in FIG. 1.

The first surveillance camera comprises a spherically or parabolically convex mirror 1 and a digital camera 2 that constitutes a CCD camera. A second surveillance camera is constructed correspondingly from a second mirror 3, which is designed as a spherically or parabolically convex mirror 3, and from a CCD camera 4. The two mirrors 1, 3 are arranged on the roof of the vehicle in the interior. The two cameras 2, 4 are arranged below the two mirrors 1, 3 and have the two mirrors 1, 3 in their field of view, in particular comprising the essential field of view of the cameras 2, 4. Such surveillance cameras are described in, for example, said international patent documents WO 99/30197, WO 99/45422 and WO 97/43854. The convex mirror 1 is fitted in this example on the roof above the area between the front seats, the reflecting surface pointing downward, and the assigned camera 2 being fastened between the two front seats with sight line upward in the direction of the mirror 1. The second convex mirror 3 is arranged in the middle of the vehicle roof. Its reflecting surface likewise points downward. The camera 4 is arranged below the mirror 3 in the footwell of the vehicle in the rear compartment in the region of the transmission tunnel such that it is aligned with the mirror 3.

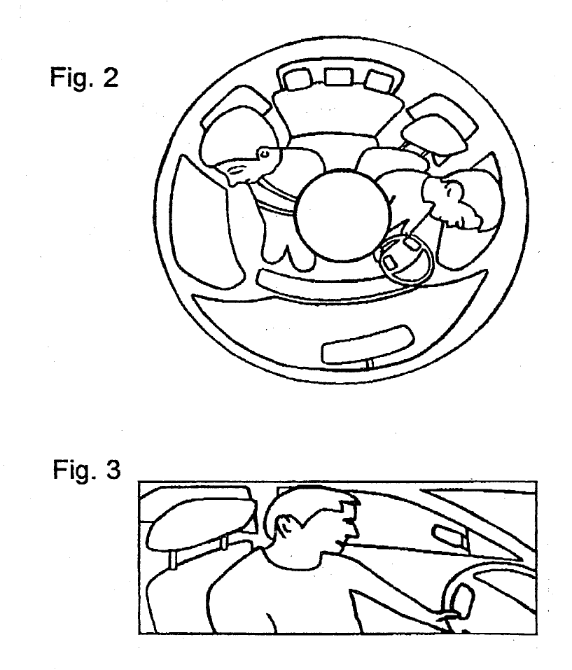

In the case of this arrangement, the camera 2 or 4 sees in the assigned convex mirror 1, 3 an image of the hemisphere below the roof of the vehicle as illustrated schematically by way of example in FIG. 2. Here, with the exception of a mechanically or electronically masked central region in which it would image itself, the image shows the hemisphere named above. As may be gathered from FIG. 2, the camera senses not only the interior with the seats and the vehicle occupants, it is also capable of sensing the area outside through the windscreen, details of the exterior not having been illustrated in FIG. 2, in order to improve comprehensibility. The illustration was limited to reproducing the window panes, in order to improve clarity, and so the exterior is not reproduced.

The digital image data supplied by the cameras 2, 4 are strongly distorted, since they image the surroundings in spherical or some other curvilinear coordinates, depending on the shape of the mirror. Each image of the cameras 2, 4 is fed to a rectifying unit 5 in which one or more parts of the image are transformed to plane coordinates. An exemplary transformed image of the driver side is illustrated in FIG. 3. The image illustrated shows a relatively undistorted image in which straight lines are also reproduced as substantially straight lines.

The transformed image data are fed to a selection stage 6 which is now enabled in a simple way on the basis of the transformed, rectified image data to select interesting areas of the image recorded by the cameras 2, 4 by analyzing contours, colors and movements, for example using the concept of optical flux.

If the arrangement is used to monitor the interior and/or exterior in the case of a pedestrian monitoring unit, it is preferred to use a selection stage with movement analysis, while given an application as a traffic lights or traffic signs assistant it is analysis by means of a contour and/or color that are/is applied. If, in an automated process, the selection stage determines an area as particularly relevant, and thereby selects this area, an item of information representing this selected area is reported by the selection stage 6 to the control unit 7 which then uses the alignment unit 8 to swivel the second sensor 9, which includes a CCD camera with zoom function, to the effect that the field of view of the second sensor 9 covers this selected area. Here, the magnification factor (zoom factor) of the second sensor 9 is set by the control unit 7 such that the objects in the selected area can be sensed in detail. The zoom factor is selected here in accordance with the distance, determined by a stereoscopic measurement, of the selected area or of the objects in the selected area.

The stereoscopic measurement is performed in this case via the two surveillance cameras 1, 2/3, 4, which together form a stereoscopic surveillance camera. The stereoscopic evaluation is performed here by the selection stage 6, which makes available the distance information of the control unit 7, which consequently controls the zoom of the second sensor 9.

The image data recorded by the second sensor 9 and the two surveillance cameras 1, 2/3, 4 are fed to an image evaluation unit 10 that permits an overall evaluation of the image data of all the sensing systems, and thus of the two sensors, that is to say the first surveillance camera 1, 2, the second surveillance camera 3, 4 and the zoom camera 9. It is possible in the course of the overall evaluation in particular to resolve instances of ambiguity and/or to permit a very specific evaluation of the spatial subdivision of the sensed exterior and/or interior. As a result, it is possible in particular to determine distances and/or positions of objects individually sensed. Moreover, relative speeds of sensed objects can also be calculated in relation to the vehicle or to the sensor arrangement. It is possible precisely by means of the exemplary overall evaluation of all image information to obtain information that is very informative and reliable for the purpose of constructing the exterior and/or the interior of the vehicle. With the aid of this secure and reliable information, other components of a vehicle can make necessary measures available, for example warnings to the driver or codriver or measures for further information for the driver and/or co-driver, and/or initiate measures for reducing effects of accidents such as, for example, early inflation of airbags or early inclining of the engine hood before a pedestrian impact on the vehicle, or measures for automatically braking or accelerating a vehicle or avoiding contact by it. For this purpose, the required information of the image evaluation unit is made available to these other components of the vehicle via an interface 11.

The method according to the present invention is suitable in a particularly advantageous way for use in vehicles, particularly in conjunction with a device for protection against theft, or with a device for transmitting image data. In particular, the image data are transmitted via a mobile radio telephone to persons, for example an owner of a motor vehicle, as soon as the alarm system or the antitheft device is activated.

Moreover, the present invention is particularly suitable for cooperating with a recording system that senses and stores the driving situation at the same time as an accident both in the interior and in the exterior of the vehicle such that a later analysis of the accident is permitted. Owing to the cooperation of the two sensors once as panoramic sensor (surveillance cameras), and once as selected sensor (second sensor) for particularly relevant areas, it proves to be very helpful that precisely the information that is particularly important for an accident situation, for example the overall view, but also special areas can be sensed and documented specifically.

The method according to the present invention also exhibits particular strengths for an application in conjunction with an airbag triggering system, since it is capable of sensing the position of the occupants, in particular the head position and/or the alignment of the occupants, and correspondingly of controlling suitable measures for triggering the airbags, particularly with regard to the triggering instant and the triggering rate down to not triggering an airbag, doing so specifically in a fashion adapted to the situation. This results, in particular, in preventing the triggering of airbags in situations such as when a vehicle occupant undesirably sits down comfortably by placing his feet on the dashboard, in which the airbag is accommodated. Were the airbag to be triggered, given this position of the occupant, serious injuries would result for him in the leg region, but also in the head region, which will not arise without triggering the airbag. Consequently, in cooperation with other components of the vehicle the present invention leads to an enhanced traffic safety of the driver and/or the other occupants of the vehicle, on the one hand, but also for the other road users.

What is claimed is:

1. A method for monitoring a space of a vehicle comprising:
sensing the space using a first sensor including at least one surveillance camera so as to produce an image data;
performing an evaluation of the image data;
selecting at least one area of the space using the evaluation of the image data;
sensing the at least one area using a second alignable sensor having a restricted spatial sensing range so as to produce a second data; and
evaluating the second data.

2. The method as recited in claim 1 wherein the space of the vehicle includes at least one of an interior of the vehicle and an exterior of the vehicle.

3. The method as recited in claim 1 further comprising aligning the second sensor.

4. The method as recited in claim 3 wherein the aligning of the second sensor is performed using a control unit based on the evaluation of the image data.

5. The method as recited in claim 4 wherein the aligning is performed electronically.

6. The method as recited in claim 4 wherein the aligning is performed using a motor.

7. The method as recited in claim 4 wherein the evaluation of the image data is performed automatically using the control unit.

8. The method as recited in claim 7 wherein the evaluation of the image data includes analyzing at least one of a movement, a contour and a color.

9. The method as recited in claim 1 wherein the evaluating of the second data includes analyzing at least one of a distance and a relative speed of an object in the at least one area.

10. The method as recited in claim 1 wherein the image data has curvilinear coordinates and further comprising transforming the image data so as to have cylindrical or plane coordinates before the evaluation of the image data is performed.

11. A vehicle comprising:
a first sensor including at least one surveillance camera disposed in an interior of the vehicle, the first sensor having a field of view covering at least one of a portion of the interior and a portion of an exterior of the vehicle; and
a second alignable sensor having a restricted spatial sensing range, an alignment of the second sensor being controllable using the first sensor.

12. The vehicle as recited in claim 111 wherein the first sensor produces image data and further comprising:
an electric or motor drive;
a control unit; and
a selection stage for performing an automated evaluation of the image data, wherein the drive and the control unit are configured to align the second sensor using the automated evaluation.

13. The vehicle as recited in claim 11 wherein the first sensor is disposed in a region of the inside mirror.

14. The vehicle as recited in claim 11 wherein the first sensor includes two surveillance cameras jointly forming a stereo image camera.

15. The vehicle as recited in claim 11 wherein the second sensor includes at least one of a digital camera, an infrared camera, a laser point sensor and a radar sensor.

16. The vehicle as claimed in claim 11, wherein the second sensor includes a zoom function controllable as a function of a distance.

17. The vehicle as claimed in claim 16 wherein the second sensor is capable of stereoscopic sensing.

18. The vehicle as recited in claim 11, wherein the second sensor is at least partially disposed in a region of a dashboard of the vehicles.

19. The vehicle as recited in claim 11 wherein the second sensor is at least partially disposed at a one of a bumper, a headlamp and a roof edge of the vehicle.
